(19) United States
(12) Patent Application Publication
(10) Pub. No.: US 2026/0142906 A1
(43) Pub. Date: May 21, 2026

(54) METHOD AND APPARATUS FOR DETERMINING A ROUND-TRIP DELAY IN A COMMUNICATION NETWORK

(71) Applicant: Telecom Italia S.p.A., Milano (IT)

(72) Inventors: Maurizio DE PAOLA, Torino (IT); Domenico ORTO, Lipari (IT)

(73) Assignee: Telecom Italia S.p.A., Milano (IT)

(21) Appl. No.: 18/706,016

(22) PCT Filed: Oct. 20, 2022
(86) PCT No.: PCT/EP2022/079289

§ 371 Date: Apr. 30, 2024

(30) Foreign Application Priority Data
Nov. 18, 2021 (IT) 102021000029228

(51) Int. Cl. H04L 43/0864; H04L 61/5007

(52) U.S. Cl. CPC H04L 43/0864; H04L 61/5007

(57) ABSTRACT

A method is proposed for determining a round-trip delay time (RTT) between first and second points of a communication network based on data units propagating according to a first protocol belonging to a first protocol layer, and to a second protocol belonging to a second protocol layer higher than the first protocol layer, wherein said data units comprise first and second data units that, during propagation, are at the first and second points, respectively.

### BACKGROUND OF THE INVENTION

### Field of the Invention

The present invention relates to a method and system for determining a round-trip delay time in a communication network.

### Overview of the Related Art

A long delay or travel time of data units in a communication network may be indicative of deficiencies of the communication network that are to be addressed in order to improve performance.

Measurement of the delay or travel time (usually referred to as round-trip delay time or RTT time) is conventionally accomplished, in a client-server architecture, by measuring the time between transmission of a request message from the client and the reception at the client of a response message generated by the server in response to the request message.

Ping (“Packet INternet Groper”) is an administration utility for computer networks used to measure the time (usually of the order of milliseconds) taken by one or more ICMP (“Internet Control Message Protocol”) packets to reach a network device (through any IP-based computer network) and to go back to the origin. It is mainly used to check the presence and reachability of another computer connected to the network and to measure network transmission latencies.

US20030231636 discloses a method of performing RTT time measurement in a data packet receiver using a “Transmission Control Protocol” (TCP) for communication via a network with a sender. The method comprises the steps of sending an acknowledgement for a currently received data packet to the sender, measuring a first time instant when sending the acknowledgement, triggering at the sender the transmission of an expected data-packet, measuring a second time instant when the expected data packet is received, and calculating the round-trip time based on the measured first and second time instants.

Distributed probe systems with time synchronization are also known. In these systems, distributed probes are provided at a plurality of measurement points both at client side and at server side to perform message tracing with a centralized synchronization mechanism configured to synchronize all the measurement points to each other.

U.S. Pat. No. 5,521,907 discloses a measurement of round-trip delay or travel time in a communications network during in-service operation accomplished by use of two probes, situated at respective points of interest along the communication network, and a processor. The probes receive identifiable data patterns normally transmitted over the communications network and generate a time stamp when each pattern arrives at or leaves the respective point. Each probe further generates a pattern identifier based on the data in the pattern and stores the identifier and time stamp as a pair in a buffer internal to each probe. Once the internal buffer contents exceed a predetermined amount of data, the processor receives the data from the buffers and matches pattern identifiers between the buffers to locate the departure and arrival time stamps of each pattern traveling between the probe points. Thereafter, the processor calculates an average of round-trip delay or travel times based on the departure and arrival time stamps of several patterns traveling in both directions between the probe points.

### SUMMARY OF INVENTION

The Applicant has found that the known method and apparatuses for measuring the RTT time in a communication network are not satisfactory.

Concerning the RTT time determined based on ping messages, the Applicant has recognized the following issues. Firstly, in order to avoid DoS (“Denial of Service”) attacks, firewalls in a communication network may block ping messages, whereas some entities of the communication network may slow down response messages in response to ping messages. Secondly, data units (such as IP data packets) may change (and typically change) in size (length) while propagating through the communication network. These issues significantly affect RTT time measurement.

As far as the solution disclosed in US20030231636 is concerned, the Applicant has understood that the RTT time so determined is inherently unreliable, in that it also includes processing times that do not pertain to propagation within the communication network (for example, in a client-server architecture, the time taken by the server to receive and process a request message from the client and the time taken by the server to process and transmit a corresponding response message to the client). In communication networks featuring very low latency times, such as LTE and 5G mobile communication networks, the impact of the processing times on the RTT times is even more significant.

Concerning the distributed probe system with time synchronization, according to the Applicant the high complexity and costs of the synchronization mechanism preclude a widespread use of this system.

As far as the solution disclosed in U.S. Pat. No. 5,521,907 is concerned, the Applicant has understood that the use of specific identification parameters for each protocol makes such a solution not applicable in modern communication networks where these identification parameters are modified/changed by the communication network and are not fixed in end-to-end communication.

In this respect, the Applicant has faced the above-mentioned issues, and has devised a method and apparatus for determining, in a communication network, a RTT time which is not affected by processing times, which is easy and cheap to implement, which provides for a reliable indication of the conditions of the communication network, and which is essentially unaffected by manipulations of data units propagating within the communication network.

One or more aspects of the present invention are set out in the independent claims, with advantageous features of the same invention that are indicated in the dependent claims, whose wording is enclosed herein verbatim by reference (with any advantageous feature being provided with reference to a specific aspect of the present invention that applies mutatis mutandis to any other aspect).

More specifically, an aspect of the present invention relates to a method for determining a round-trip delay time between first and second points of a communication network based on data units propagating according to a first protocol belonging to a first protocol layer, and to a second protocol belonging to a second protocol layer higher than the first protocol layer. Said data units comprise first and second data units that, during propagation, are at the first and second points, respectively. The method may comprise associating with each first data unit a respective first timestamp with respect to a first reference time. The method may comprise associating with each second data unit a respective second timestamp with respect to a second reference time different from the first reference time. The method may comprise recognizing, among said first and second data units, first messages each one comprising a respective pair of first and second data units that propagate in a first direction between the first and second points and that match to each other based on the first protocol. The method may comprise recognizing, among said first and second data units, second messages each one comprising a respective pair of first and second data units that propagate in a second direction opposite the first direction and that match to each other based on the first protocol. The method may comprise identifying, among said first and second messages, a round-trip message comprising a pair of first and second messages wherein the second message has been originated, according to the second protocol, in response to the first message. The method may comprise determining the round-trip delay time based on the first and second timestamps associated with the first and second data units of the round-trip message.

According to an embodiment, whose features are additional or alternative to any features of the previous embodiments, said determining the round-trip delay time comprises determining the round-trip delay time based on a difference between:
a difference between the first timestamps associated with the first data units of the round-trip message, and
a difference between the second timestamps associated with the second data units of the round-trip message.

According to an embodiment, whose features are additional or alternative to any features of the previous embodiments, the first protocol comprises a network layer protocol.

According to an embodiment, whose features are additional or alternative to any features of the previous embodiments, the first protocol comprises the IP protocol.

According to an embodiment, whose features are additional or alternative to any features of the previous embodiments, the first and second data units of each one of said pairs of first and second data units match to each other based on the “Identification” field of IP header.

According to an embodiment, whose features are additional or alternative to any features of the previous embodiments, the second protocol comprises a synchronous protocol.

According to an embodiment, whose features are additional or alternative to any features of the previous embodiments, the second protocol comprises at least one among:
TCP protocol;
UDP protocol;
HTTP protocol,
QUIC protocol.

According to an embodiment, whose features are additional or alternative to any features of the previous embodiments, said identifying the round-trip message comprises determining that, for said pair of first and second messages, the second message has been originated in response to the first message based on a correlation between a request parameter of the first message and a response parameter of the second message.

According to an embodiment, whose features are additional or alternative to any features of the previous embodiments, the second protocol comprises the HTTP protocol. The request parameter of the first message may comprise the “Method” field and the response parameter of the second message may comprise the “Status Code” field.

According to an embodiment, whose features are additional or alternative to any features of the previous embodiments, the second protocol comprises the TCP protocol. The request parameter of the first message may comprise the sequence number and the response parameter of the second message may comprise the acknowledgment number.

According to an embodiment, whose features are additional or alternative to any features of the previous embodiments, the second protocol comprises the QUIC protocol. The request parameter of the first message may comprise the “Connection ID” and “Packet Number” fields of the first message and the response parameter of the second message may comprise the “Connection ID” and “Packet Number” fields of the second message.

According to an embodiment, whose features are additional or alternative to any features of the previous embodiments, the first and second points of the communication network comprise mutually opposite end points of a network entity or group of network entities of the communication network.

Another aspect of the present invention relates to an apparatus for determining a round-trip delay time between first and second points of a communication network based on data units propagating according to a first protocol belonging to a first protocol layer, and to a second protocol belonging to a second protocol layer higher than the first protocol layer. The apparatus may comprise a first acquisition apparatus configured to acquire first data units comprising data units that, during propagation, are at the first point, and to associate with each first data unit a respective first timestamp with respect to a first reference time. The apparatus may comprise a second acquisition apparatus configured to acquire second data units comprising data units that, during propagation, are at the second point, and to associate with each second data unit a respective second timestamp with respect to a second reference time. The apparatus may comprise a recognizing apparatus for recognizing, among said first and second data units, first messages each one comprising a respective pair of first and second data units that propagate in a first direction between the first and second points and that match to each other based on the first protocol, and second messages each one comprising a respective pair of first and second data units that propagate in a second direction opposite the first direction and that match to each other based on the first protocol. The apparatus may comprise an identification apparatus for identifying, among said first and second messages, a round-trip message comprising a pair of first and second messages wherein the second message has been originated, according to the second protocol, in response to the first message. The apparatus may comprise a processing apparatus for determining the round-trip delay time based on the first and second timestamps associated with the first and second data units of the round-trip message.

### BRIEF DESCRIPTION OF THE ANNEXED DRAWINGS

These and other features and advantages of the present invention will be made apparent by the following description of some exemplary and non-limitative embodiments thereof. For its better intelligibility, the following description should be read referring to the attached drawings, wherein:

FIG. 1 shows a system according to an embodiment of the present invention, and

FIG. 2 shows an activity diagram of a method according to an embodiment of the present invention.

### DETAILED DESCRIPTION OF PREFERRED EMBODIMENTS OF THE INVENTION

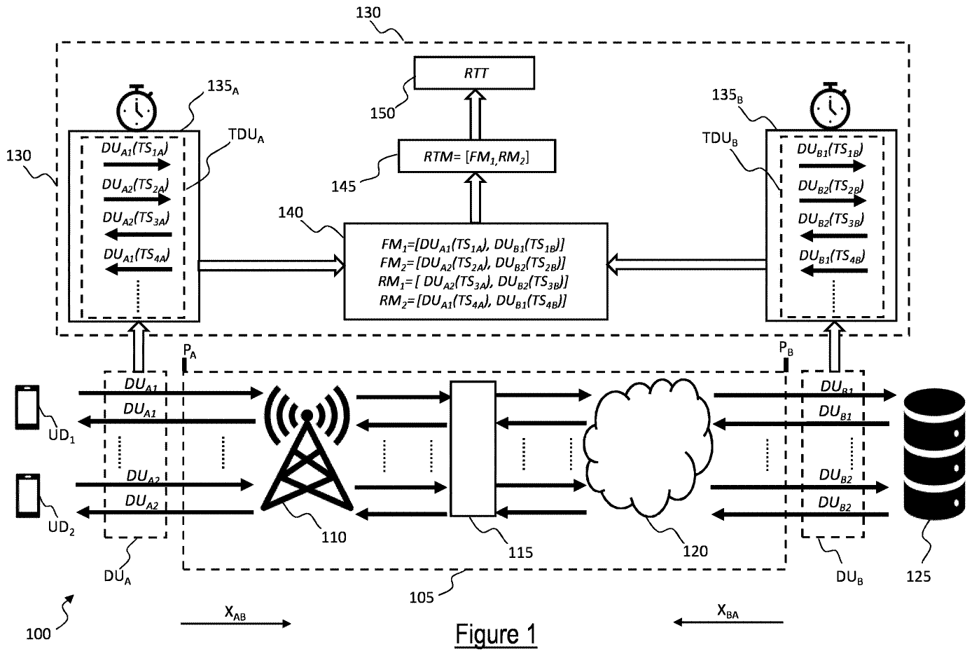

With reference to the drawings, FIG. 1 shows a system 100 according to an embodiment of the present invention.

In the following, when one or more features of the system 100 are introduced by the wording “according to an embodiment”, they are to be construed as features additional or alternative to any features previously introduced, unless otherwise indicated and/or unless there is evident incompatibility among feature combinations.

In the following, only relevant features of the system 100 that are deemed relevant for the understanding of the present invention will be discussed, with well-known and/or obvious variants of the relevant features that are omitted for the sake of conciseness.

According to an embodiment, the system 100 comprises a communication network 105.

The communication network 105 may comprise a wired communication network, a wireless communication network, or a combination thereof.

According to an embodiment, the communication network 105 comprises a radio access network 110. Without losing generality, the radio access network 110 may be based on any suitable radio access technology. Examples of radio access technologies comprise, but are not limited to, UTRA (“UMTS Terrestrial Radio Access”), WCDMA (“Wideband Code Division Multiple Access”), CDMA2000, GERAN (“GSMEDGERadio Access Network”), LTE (“Long Term Evolution”), LTE-Advanced, and 5G NR (“New Radio”).

According to an embodiment, the communication network 105 comprises a core network 115. According to an embodiment, the core network 115 is communicably coupled (e.g., by a wired and/or wireless coupling) to the radio access network 110.

According to an embodiment, the communication network 105 comprises one or more external networks, such as the Internet network 120. According to an embodiment, the Internet network 120 is communicably coupled (e.g., by a wired and/or wireless coupling) to the core network 115.

In alternative embodiments, not shown, the communication network 105 may comprise one or more external networks other than the Internet network 120, such as public switched telephone networks.

According to an embodiment, the system 100 comprises a service server 125 (or more thereof) for providing one or more functionalities or services for client devices, such as connectable devices (as discussed here below). Examples of functionalities or services provided by the service server 125 comprise, but are not limited to, data or resources sharing among multiple client devices, and computations for a client device. Just as a non-exhaustive example, the service server 125 may comprise one or more among a database server, a file server, a mail server, a print server, a web server, a game server, and an application server.

According to an embodiment, the service server 125 is communicably coupled to the Internet network 120 (e.g., by a wired and/or wireless coupling)

According to an embodiment, the communication network 105 allows one or more connectable devices connecting or connected to the communication network 105 (e.g., through the radio access network 110) to access the services provided by the service server 125. In FIG. 1, two connectable devices UD₁, UD₂ are exemplarily shown for ease of representation.

According to an embodiment, the connectable devices comprise computing devices having connection capabilities to the communication network 105. Examples of connectable devices comprise, but are not limited to, mobile phones, smartphones, tablets, personal digital assistants (PDAs), laptop computers, home automation devices and autonomous devices (such as self-driving vehicles).

According to an embodiment, the communication network 105 is configured to propagate data units according to a first protocol belonging to a first protocol layer of the OSI (“Open Systems Interconnection”) model (or of another model), and according to a second protocol belonging to a second protocol layer of the OSI model (or of another model).

According to standard ISO 7498, the OSI model is a conceptual model that split the communication functions of a telecommunication system into classes of functionalities realized in software by standardized communication protocols, from the physical layer protocol (lowest-layer protocol) to the application layer protocol (highest-layer protocol).

According to an embodiment, the second protocol layer is a protocol layer that, with reference to the OSI model, is higher than the first protocol layer (reason why, in the following, the first protocol layer will be referred to as lower-layer protocol and the second protocol layer will be referred to as higher-layer protocol).

According to an embodiment, the lower-layer protocol comprises a synchronous protocol.

According to an embodiment, the higher-layer protocol comprises a synchronous protocol.

For the purposes of the present disclosure, by synchronous protocol it is herein meant that the protocol provides for time synchronization before data unit transmission.

With reference to the OSI model, an example of lower-layer protocol comprises, but is not limited to, a network layer protocol (such as the IP (“Internet Protocol”) protocol).

With reference to the OSI model, examples of higher-layer protocol comprise, but are not limited to, a transport layer protocol (such as the TCP (“Transmission Control Protocol”) protocol, the UDP (“User Datagram Protocol”) protocol, and the QUIC protocol), and application layer protocol (such as the HTTP (“Hypertext Transfer Protocol”) protocol).

With reference to the OSI model, examples of data units comprise, but are not limited to, data packets (network layer protocol), data packet segments or datagrams (transport layer protocol), and data (application layer).

According to an embodiment, the system 100 comprises a “Round-Trip delay Time” apparatus (hereinafter, RTT apparatus) 130 for determining a round-trip delay time (hereinafter, RTT time) between first P_{A} and second P_{B} points of the communication network 105. According to an embodiment, the RTT apparatus 130 is configured to determine the RTT time between the first P_{A} and second P_{B} points of the communication network 105 based on the data units propagating between the first P_{A} and second P_{B} points of the communication network 105.

According to an embodiment, as exemplary illustrated, the first P_{A} and second P_{B} points of the communication network 105 identify or comprise mutually opposite end points of the communication network 105. Therefore, in this embodiment, the RTT apparatus 130 is configured to determine the RTT time associated with the whole communication network 105.

In alternative embodiments, the first P_{A} and second P_{B} points of the communication network 105 may be any intermediate points of the communication network 105 being intermediate with respect to the end points: in these embodiments, the RTT apparatus 130 is configured to determine the RTT time associated with a portion of the communication network 105 delimited by (i.e., between) such intermediate points. In practical implementations, the first P_{A} and second P_{B} points of the communication network 105 may identify or comprise mutually opposite end points of a network entity or group of network entities of the communication network 105, so that the RTT apparatus 130 may be configured to determine the RTT time associated with that network entity or group of network entities only.

Just as an example, the first P_{A} and second P_{B} points of the communication network 105 may identify or comprise mutually opposite end points of the radio access network 110 (or of other network entity), so that the RTT apparatus 130 may be configured to determine the RTT time associated with the radio access network 110 only.

Just as another example, the first P_{A} and second P_{B} points of the communication network 105 may identify or comprise mutually opposite end points of the core network 115 (or of other network entity), so that the RTT apparatus 130 may be configured to determine the RTT time associated with the core network 115 only.

Just as a further example, the first P_{A} and second P_{B} points of the communication network 105 may identify or comprise mutually opposite end points of the radio access network 110/core network 115 (or of other group of network entities), so that the RTT apparatus 130 may be configured to determine the RTT time across the portion of the communication network 105 including the radio access network 110 and the core network 115 only.

As it should be understood, the data units at the first point P_{A} of the communication network 105 and the data units at the second point P_{B} of the communication network 105 that represent a same message may have (and typically have) mutually different structures (due to data unit manipulation during propagation between the first P_{A} and second P_{B} points of the communication network 105).

In the following, the data units that, during propagation, are at the first point P_{A} of the communication network 105 will be globally denoted by first data units DU_{A}, and the data units that, during propagation, are at the second point P_{B} of the communication network 105 will be globally denoted by second data units DU_{B}. In the exemplary considered scenario in which two connectable devices are provided, the first data units DU_{A} may comprise data units associated with (i.e., to/from) the user device UD₁, and/or data units associated with (i.e., to/from) the user device UD₂, and the second data units DU_{B} may comprise data units associated with (i.e., to/from) the user device UD₁, and/or data units associated with (i.e., to/from) the user device UD₂.

In the simplified example herein considered, the first data units DU_{A} comprise data units DU_{A1} associated with the user device UD₁ and data units DU_{A2} associated with the user device UD₂, and the second data units DU_{B} comprise data units DU_{B1} associated with the user device UD₁ and data units DU_{B2} associated with the user device UD₂.

As conceptually represented in the figure by arrows having opposite directions, the first DU_{A} and second DU_{B} data units may comprise, as in a practical scenario, both data units that propagate in a first direction X_{AB} from the first point P_{A} to the second point P_{B} of the communication network 105 (e.g., from the user devices to the service server 125, in the practical client-server scenario herein considered), and data units that propagate in a second direction X_{BA} from the second point P_{B} to the first point P_{A} of the communication network 105 (e.g., from the service server 125 to the user devices, in the practical client-server scenario herein considered). In the simplified example herein considered, each one among the data units DU_{A1}, the data units DU_{A2}, the data units DU_{B1} and the data units DU_{B2} comprises a respective data unit propagating in the first direction X_{AB} and a respective data unit propagating in the second direction X_{BA}.

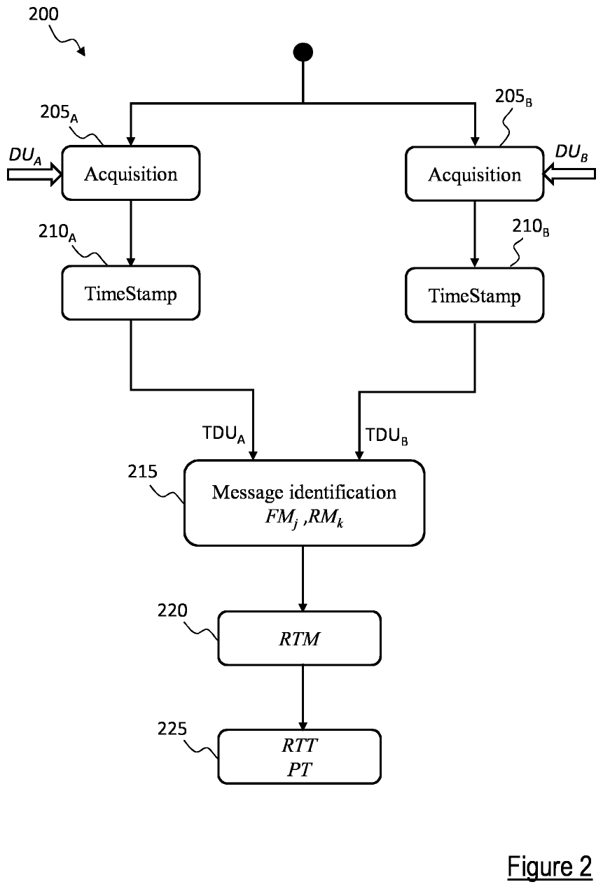

In the following, reference will be also made to FIG. 2, which schematically shows an activity diagram of a method 200 implemented by the RTT apparatus 130 for determining the RTT time. According to an embodiment, the RTT apparatus 130 comprises a first acquisition apparatus 135_{A} configured to acquire the first data units DU_{A}, i.e. capture the first data units DU_{A} while the communications network 105 is in-service and without affecting propagation thereof (action node 205_{A}).

According to an embodiment, the first acquisition apparatus 135_{A} is located at (i.e., in correspondence of) the first point P_{A} of the communication network 105.

According to an embodiment, the first acquisition apparatus 135_{A} is configured to associate, with each (acquired) first data unit DU_{A}, a respective timestamp TS_{nA} (n=1, 2, . . . N) with respect to a reference time RT_{A} of the first acquisition apparatus 135_{A}, thereby obtaining a plurality of timestamped first data units TDU_{A} (action node 210A). In the simplified example herein considered, the following timestamped first data units TDU_{A} are obtained, ordered by increasing timestamp from timestamp TS_{1A} to timestamp TS_{4A} with respect to the reference time RT_{A}:
the timestamped first data unit DU_{A1}(TS_{1A}) comprising the data unit DU_{A1}, propagating in the first direction X_{AB}, associated with timestamp TS_{1A};
the timestamped first data unit DU_{A2}(TS_{2A}) comprising the data unit DU_{A2}, propagating in the first direction X_{AB}, associated with the timestamp TS_{2A};
the timestamped first data unit DU_{A2}(TS_{3A}) comprising the data unit DU_{A2}, propagating in the second direction X_{BA}, associated with the timestamp TS_{3A}, and
the timestamped first data unit DU_{A1}(TS_{4A}) comprising the data unit DU_{A1}, propagating in the second direction X_{BA}, associated with the timestamp TS_{4A}.

According to an embodiment, the first acquisition apparatus 135_{A} may be a physical probe, for example an external physical probe being external to the communication network 105.

According to an embodiment, the first acquisition apparatus 135_{A} may be a software application, for example a software application (e.g., TCPDUMP for Linux-based operating systems) running on suitable hardware within the communication network 105.

According to an embodiment, the RTT apparatus 130 comprises a second acquisition apparatus 135_{B} configured to acquire the second data units DU_{B}, i.e. capture the second data units DU_{B} without affecting propagation thereof (action node 205B).

According to an embodiment, the second acquisition apparatus 135_{B} is located at (i.e., in correspondence of) the second point P_{B} of the communication network 105.

According to an embodiment, the second acquisition apparatus 135_{B} is configured to associate, with each (acquired) second data unit DU_{B}, a respective timestamp TS_{nB} (n=1, 2, . . . N) with respect to a reference time RT_{B} of the second acquisition apparatus 135_{B}, thereby obtaining a plurality of timestamped second data units TDU_{B} (action node 210_{B}). In the simplified example herein considered, the following timestamped second data units TDU_{B} are obtained, ordered by increasing timestamp from timestamp TS_{1B} to timestamp TS_{4B} with respect to the reference time RT_{B}:
the timestamped second data unit DU_{B1}(TS_{1B}) comprising the data unit DU_{B1}, propagating in the first direction X_{AB}, associated with timestamp TS_{1B};
the timestamped second data unit DU_{B2}(TS₂) comprising the data unit DU_{B2}, propagating in the first direction X_{AB}, associated with the timestamp TS_{2B};
the timestamped second data unit DU_{B2}(TS_{3B}) comprising the data unit DU_{B2}, propagating in the second direction X_{BA}, associated with the timestamp TS_{3B}, and
the timestamped second data unit DU_{B1}(TS_{4B}) comprising the data unit DU_{B1}, propagating in the second direction X_{BA}, associated with the timestamp TS_{4B}.

According to an embodiment, the second acquisition apparatus 135_{B} may be a physical probe, for example an external physical probe being external to the communication network 105.

According to an embodiment, the second acquisition apparatus 135_{B} may be a software application, for example a software application (e.g., TCPDUMP for Linux-based operating systems) running on suitable hardware within the communication network 105.

Since the reference time RT_{A} and the reference time RT_{B} are different from each other, the first 135_{A} and second 135_{B} acquisition apparatuses are asynchronous to each other, whereby the RTT apparatus 130 allows avoiding the use of complex and expensive synchronization mechanisms.

According to an embodiment, the RTT apparatus 130 comprises a recognizing apparatus 140 for recognizing, among the (acquired) first DU_{A} and second DU_{B} data units (particularly, the first DU_{A} and second DU_{B} data units associated with a same connectable device), pairs of first DU_{A} and second DU_{B} data units that propagate in the same direction and that match to each other based on the lower-layer protocol (action node 215).

According to an embodiment, each pair of first DU_{A} and second DU_{B} data units associated with a same connectable device that propagate in the first direction X_{AB} and that match to each other based on the lower-layer protocol is recognized by the recognizing apparatus 140 as a respective first message FMⱼ. As better discussed in the following, in the practical client-server scenario herein considered, each first message FMⱼ may for example be a request message from the client to the server, or a response message from the client to the server in response to a request message from the server to the client.

According to an embodiment, each pair of first DU_{A} and second DU_{B} data units associated with a same user device that propagate in the second direction X_{BA} and that match to each other based on the lower-layer protocol is recognized by the recognizing apparatus 140 as a respective second message RMₖ. In the practical client-server scenario herein considered, each second message RMₖ may for example be a request message from the server to client, or a response message from the server to the client in response to a request message from the client to the server.

According to an embodiment, the recognizing apparatus 140 is communicably coupled to the first 135_{A} and second 135_{B} acquisition apparatuses for receiving the timestamped first data units TDU_{A} and the timestamped second data units TDU_{B}, respectively, and for providing the recognized first FMⱼ and second RMₖ messages.

In the exemplary considered embodiment, two first messages FM₁, FM₂ and two second messages RM₁, RM₂ are recognized. In the exemplary considered embodiment:
the first message FMⱼ comprises the timestamped first data unit DU_{A1}(TS_{1A}) and the timestamped second data unit DU_{B1}(TS_{1B});
the first message FM₂ comprises the timestamped first data unit DU_{A2}(TS_{2A}) and the timestamped second data unit DU_{B2}(TS_{2B});
the second message RM₁ comprises the timestamped first data unit DU_{A2}(TS_{3A}) and the timestamped second data unit DU_{B2}(TS_{3B});
the second message RM₂ comprises the timestamped first data unit DU_{A1}(TS_{4A}) and the timestamped second data unit DU_{B1}(TS_{4B}).

According to an embodiment, the recognizing of a first data unit and of a second data unit (among the first DU_{A} and second DU_{B} data units) as representing a same message depends on the lower-layer protocol being used for data unit transmission.

Considering, for instance, the IP protocol as an example of lower-layer protocol, according to an embodiment a first data unit and a second data unit (among the first DU_{A} and second DU_{B} data units) are recognized as representing a same message if they match to each other based on a value of the “Identification” field of the IP header. Since the “Identification” field is a unique 16-bit value that is unchanged during propagation of the data units within the communication network 105, a first data unit and a second data unit are recognized as representing a same message if they have same value of the “Identification” field of the IP header.

According to an embodiment, the recognizing apparatus 140 comprises a conventional personal computer or other general-purpose computer. According to an embodiment, the recognizing apparatus 140 may be provided at any location having a communication capability with the first 135_{A} and second 135_{B} acquisition apparatuses.

According to an embodiment, the RTT apparatus 130 comprises an identification apparatus 145 configured to identify, among the first FMⱼ and second RMₖ messages, a round-trip message RTM, or more thereof (action node 220). According to an embodiment, the round-trip message RTM (or each round-trip message RTM) comprises a pair of first FMⱼ and second RMₖ messages wherein the second message RMₖ has been originated, according to the higher-layer protocol, in response to the first message FMⱼ (or, equivalently, wherein the first message FMⱼ has been originated, according to the higher-layer protocol, in response to the second message RMₖ). Otherwise stated, the round-trip message RTM comprises a pair of first FMⱼ and second RMₖ messages wherein one of the messages (i.e., the first message FMⱼ or the second message RMₖ) is a request message and the other message (i.e., the second message RMₖ or the first message FMⱼ, respectively) is a response message being originated, according to the higher-layer protocol, in response to the request message.

In the exemplary considered embodiment, a single round-trip message RTM is identified.

In the exemplary considered embodiment, the round-trip message RTM comprises the first message FMⱼ and the second message RM₂.

According to an embodiment, the identification apparatus 145 is configured to identify the round-trip message RTM according to a correlation between the first FMⱼ and second RMₖ messages, the correlation between the first FMⱼ and second RMₖ messages being for example based on the higher-layer protocol.

According to an embodiment, the determination that a second (or first) message has been originated in response to a certain first (or second, respectively) message is based on a correlation between a request parameter of the first (or second, respectively) message and a response parameter of the second (or first, respectively) message.

The determination of request and response messages depends on the higher-layer protocol being used for transmission.

Considering, for instance, the HTTP protocol as an example of higher-layer protocol, the determination that a second (or first) message has been originated in response to a certain first (or second, respectively) message is based on a correlation between the “Method” field of the first (or second, respectively) message and the “Status Code” field of the second (or first, respectively) message. Indeed, according to HTTP protocol, the “Method” field of a request message is indicative of the request (such as “GET”, “POST”, “PUT”, “DELETE”, “TRACE”, “OPTIONS”, “CONNECT”, “PATCH”), and the “Status Code” field of the corresponding response message is indicative of an outcome of that request.

Therefore, considering the HTTP protocol as an example of higher-layer protocol, the request parameter of the first (or second, respectively) message comprises the “Method” field and the response parameter of the second (or first, respectively) message comprises the “Status Code” field.

Considering, for instance, the TCP protocol as another example of higher-layer protocol, the determination that a second (or first) message has been originated in response to a certain first (or second, respectively) message may be based on sequence and acknowledgment numbers (and, particularly, on the progressivity of the sequence and acknowledgment numbers) associated with SYN, SYN-ACK and ACK messages exchanged during a connection establishment procedure between a client and a server (three-way handshake):
SYN message: the client sends a SYN message to the server. The client sets the sequence number of the data unit forming the SYN message at a random value A;
SYN-ACK message: in response, the server replies with a SYN-ACK message. The acknowledgment number is set at value A+1. The server sets the sequence number of the data unit forming the SYN-ACK message at a random value B;
ACK: the client sends an ACK message to the server. The sequence and acknowledgment numbers of the data unit forming the ACK message are set at values A+1 and B+1, respectively.

Therefore, considering the TCP protocol as an example of higher-layer protocol, the request parameter of the first (or second, respectively) message comprises the sequence number, and the response parameter of the second (or first, respectively) message comprises the acknowledgment number.

Considering, for instance, the QUIC protocol as a further example of higher-layer protocol, the determination that a second (or first) message has been originated in response to a certain first (or second, respectively) message may be based on the “Connection ID” and “Packet Number” fields of the first and second messages. According to QUIC protocol, the “Connection ID” field is indicative of a connection type (e.g., handshake, data transmission, or retransmission), and the “Packet Number” field is used for determining the cryptographic nonce for packet protection.

Therefore, considering the QUIC protocol as an example of higher-layer protocol, the request parameter of the first (or second, respectively) message comprises the “Connection ID” and “Packet Number” fields of the first (or second, respectively) message, and the response parameter of the second (or first, respectively) message comprises the “Connection ID” and “Packet Number” fields of the second (or first, respectively) message.

According to an embodiment, in case that the higher-layer protocol (regardless of the specific higher-layer protocol being used) provides for at least partially encrypted messages, the correlation apparatus 145 may be configured to perform decryption of the request parameter and/or of the response parameter based on corresponding decryption keys.

According to an embodiment, the correlation apparatus 145 comprises a conventional personal computer or other general-purpose computer. According to an embodiment, the correlation apparatus 145 may be provided at any location having a communication capability with the recognizing apparatus 140. According to an embodiment, the correlation apparatus 145 and the recognizing apparatus 140 may be implemented as specific functionalities of a same apparatus.

According to an embodiment, the RTT apparatus 130 comprises a processing apparatus 150 for determining the RTT time (action node 225). According to an embodiment, the processing apparatus 150 is configured to determine the RTT time based on the timestamps associated with the first and second data units of the round-trip message.

In the exemplary considered embodiment in which the round-trip message RTM comprises the first message FMⱼ as request message and the second message RM₂ as response message, and in which the first message FMⱼ comprises the timestamped first data unit DU_{A1}(TS_{1A}) and the timestamped second data unit DU_{B1}(TS_{1B}), and the second message RM₂ comprises the timestamped first data unit DU_{A1}(TS_{4A}) and the timestamped second data unit DU_{B1}(TS_{4B}), the processing apparatus 150 is configured to determine the RTT time based on timestamps TS_{1A}, TS_{1B}, TS_{4A}, TS_{4B}.

According to an embodiment, the processing apparatus 150 is configured to determine the RTT time based on a difference between an overall amount of time ORTT it took for the round-trip message to go from the first point P_{A} of the communication network 105 to the service server 125 and back to the first point P_{A}, and a processing time PT at the service server 125 (i.e., the time taken by the service server 125 to receive and process the request message and the time taken by the service server 125 to process and transmit the corresponding response message).

According to an embodiment, the processing apparatus 150 is configured to determine the overall amount of time ORTT for the round-trip message as the difference between the timestamp associated with the respective response message passing through the first point P_{A} of the communication network 105 and the timestamp associated with the respective request message passing through the first point P_{A} of the communication network 105. Otherwise stated, the processing apparatus 150 is configured to determine the overall amount of time ORTT for the round-trip message as the difference between the timestamps associated with the first data units of the round-trip message. In the exemplary considered embodiment:

$$ORTT = T {S}_{4 A} - T {S}_{1 A}$$

According to an embodiment, the processing apparatus 150 is configured to determine the processing time PT for the round-trip message as the difference between the timestamp associated with the respective response message passing through the second point P_{B} of the communication network 105 and the timestamp associated with the respective request message passing through the second point P_{B} of the communication network 105. Otherwise stated, the processing apparatus 150 is configured to determine the processing time PT for the round-trip message as the difference between the timestamps associated with the second data units of the round-trip message. In the exemplary considered embodiment:

$$P T = T {S}_{4 B} - T {S}_{1 B}$$

Since, by construction the reference time RT_{A} and the reference time RT_{B} are uncorrelated from each other, the overall amount of time ORTT also comprises the processing time PT, whereby the difference between the overall amount of time ORTT and the processing time PT results in the RTT time actually associated with the communication network 105:

$$R T T = O R T T - P T$$

In the exemplary considered embodiment:

$$R T T = T {S}_{4 A} - T {S}_{1 A} - ( {TS}_{4 B} - {TS}_{1 B} )$$

Moreover, the RTT time is determined based on data units actually exchanged between the connectable devices and the service server 125: therefore, each RTT time determined by the RTT apparatus 130 represents a reliable indication of the conditions of the communication network 105 when that RTT time is determined.

According to an embodiment, the processing apparatus 150 comprises a conventional personal computer or other general-purpose computer. According to an embodiment, the processing apparatus 150 may be provided at any location having a communication capability with the correlation apparatus 145. According to an embodiment, the processing apparatus 150 and the correlation apparatus 145 (and, possibly, the recognizing apparatus 140) may be implemented as specific functionalities of a same apparatus.

According to an embodiment, the RTT apparatus 130 is configured to continuously perform acquisition (e.g., through the first 135_{A} and second 135_{B} acquisition apparatuses) and processing (e.g., through the first 135_{A} and second 135_{B} acquisition apparatuses, the recognizing apparatus 140, the correlation apparatus 145 and the processing apparatus 150), so as to provide, over time, a succession of RTT times that reflects the conditions of the communication network 105 over time.

Naturally, in order to satisfy local and specific requirements, a person skilled in the art may apply to the invention described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof, on the contrary, well-known features may have been omitted or simplified in order not to encumber the description with unnecessary details. Moreover, it is expressly intended that specific elements and/or method steps described in connection with any disclosed embodiment of the invention may be incorporated in any other embodiment.

For example, the RTT system 130 (and, more generally, the system 100) may have a different structure or include equivalent components. Moreover, any component of the the RTT system 130 (and, more generally, of the system 100) may be separated into several elements, or two or more components may be combined into a single element; furthermore, each component can be replicated to support the execution of the corresponding operations in parallel. It should also be noted that (unless otherwise indicated) any interaction between different components generally does not need to be continuous, and may be either direct or indirect through one or more intermediaries.

Moreover, although in the foregoing explicit reference to the OSI (“Open Systems Interconnection”) model has been made, the principles of the present invention equivalently apply when considering other models characterising and/or standardising the communication functions of the telecommunication system (such as the system 100).

In addition, the present invention lends itself to be implemented through an equivalent method (by using similar steps, removing some steps being not essential, or adding further optional steps); moreover, the steps may be performed in different order, concurrently or in an interleaved way (at least partly).

1. Method for determining a round-trip delay time (RTT) between first and second points of a communication network based on data units propagating according to a first protocol belonging to a first protocol layer, and to a second protocol belonging to a second protocol layer higher than the first protocol layer, wherein said data units comprise first and second units that, during propagation, are at the first and second points, respectively, the method comprising:
associating with each first data unit a respective first timestamp with respect to a first reference time (RT_{A});
associating with each second data unit a respective second timestamp with respect to a second reference time (RT_{B}) different from the first reference time;
recognizing, among said first and second data units, first messages (FMⱼ) each one comprising a respective pair of first and second data units that propagate in a first direction between the first and second points and that match to each other based on the first protocol,
recognizing, among said first and second data units, second messages (RMₖ) each one comprising a respective pair of first and second data units that propagate in a second direction opposite the first direction and that match to each other based on the first protocol,
identifying, among said first and second messages, a round-trip message (RTM) comprising a pair of first and second messages wherein the second message has been originated, according to the second protocol, in response to the first message;
determining the round-trip delay time based on the first and second timestamps associated with the first and second data units of the round-trip message.

2. Method according to claim 1, wherein said determining the round-trip delay time comprises determining the round-trip delay time based on a difference between:
a difference between the first timestamps associated with the first data units of the round-trip message (RTM), and
a difference between the second timestamps associated with the second data units of the round-trip message (RTM).

3. Method according to claim 1, wherein the first protocol comprises a network layer protocol.

4. Method according to claim 1, wherein the first protocol comprises the IP protocol.

5. Method according to claim 4, wherein the first and second data units of each one of said pairs of first and second data units match to each other based on the “Identification” field of IP header.

6. Method according to claim 1, wherein the second protocol comprises a synchronous protocol.

7. Method according to claim 1, wherein the second protocol comprises at least one among:
TCP protocol;
UDP protocol;
HTTP protocol,
QUIC protocol.

8. Method according to to claim 1, wherein said identifying the round-trip message (RTM) comprises determining that, for said pair of first (FMⱼ) and second (RMₖ) messages, the second message has been originated in response to the first message based on a correlation between a request parameter of the first message and a response parameter of the second message.

9. Method according to claim 8, wherein the second protocol comprises the HTTP protocol, and wherein the request parameter of the first message comprises the “Method” field and the response parameter of the second message comprises the “Status Code” field.

10. Method according to claim 8, wherein the second protocol comprises the TCP protocol, and wherein the request parameter of the first message comprises the sequence number and the response parameter of the second message comprises the acknowledgment number.

11. Method according to claim 8, wherein the second protocol comprises the QUIC protocol, and wherein the request parameter of the first message comprises the “Connection ID” and “Packet Number” fields of the first message and the response parameter of the second message comprises the “Connection ID” and “Packet Number” fields of the second message.

12. Method according to to claim 1, wherein the first and second points of the communication network comprise mutually opposite end points of a network entity or group of network entities of the communication network.

13. Apparatus for determining a round-trip delay time (RTT) between first and second points of a communication network based on data units propagating according to a first protocol belonging to a first protocol layer, and to a second protocol belonging to a second protocol layer higher than the first protocol layer, wherein said data units comprise first and second data units that, during propagation, are at the first and second points, respectively, the apparatus comprising:
a first acquisition apparatus configured to acquire the first data units and to associate with each first data unit a respective first timestamp with respect to a first reference time (RT_{A});
a second acquisition apparatus configured to acquire the second data units comprising data units that, during propagation, are at the second point, and to associate with each second data unit a respective second timestamp with respect to a second reference time (RT_{B});
a recognizing apparatus for recognizing, among said first and second data units, first messages (FMⱼ) each one comprising a respective pair of first and second data units that propagate in a first direction between the first and second points and that match to each other based on the first protocol, and second messages (RMₖ) each one comprising a respective pair of first and second data units that propagate in a second direction opposite the first direction and that match to each other based on the first protocol,
an identification apparatus for identifying, among said first and second messages, a round-trip message (RTM) comprising a pair of first and second messages wherein the second message has been originated, according to the second protocol, in response to the first message;
a processing apparatus for determining the round-trip delay time based on the first and second timestamps associated with the first and second data units of the round-trip message.
